(19) United States
(12) Patent Application Publication
(10) Pub. No.: US 2025/0260054 A1
(43) Pub. Date: Aug. 14, 2025

(54) ELECTRIC STORAGE DEVICE

(71) Applicant: Prime Planet Energy & Solutions, Inc., Tokyo (JP)

(72) Inventor: Kento HOSOE, Miyoshi-shi (JP)

(21) Appl. No.: 19/038,706

(22) Filed: Jan. 28, 2025

(30) Foreign Application Priority Data
Feb. 13, 2024 (JP) 2024-019221

(51) Int. Cl. H01M 10/0567; H01M 4/02; H01M 4/505; H01M 4/525; H01M 4/583; H01M 10/0525

(52) U.S. Cl. CPC H01M 10/0567; H01M 4/505; H01M 4/525; H01M 4/583; H01M 2004/027; H01M 2004/028; H01M 10/0525

(57) ABSTRACT

A technique is provided that can suppress a capacity deterioration when an electric charge is performed on an electric storage device. The herein disclosed electric storage device includes a nonaqueous electrolytic solution. The nonaqueous electrolytic solution contains a nonaqueous solvent and an additive agent A. The nonaqueous solvent is carbonates. The additive agent A is at least one of 2-vinylpyridine, vinyl benzoate, 3,4-thiophenedicarboxylic anhydride, 1-ethyl-3-methylimidazolium methyl sulfate, 1-ethyl-3-methylimidazolium ethyl sulfate, 1-ethyl-3-methylimidazolium methylphosphonate, and 1-ethyl-3-methylimidazolium bis(perfluoroethylsulfonyl)imide.

### CROSS REFERENCE TO RELATED APPLICATIONS

The present application claims the priority based on Japanese Patent Application No. 2024-019221 filed on Feb. 13, 2024, the entire contents of which are incorporated in the present specification by reference.

### BACKGROUND OF THE DISCLOSURE

### 1. Technical Field

The present disclosure relates to an electric storage device.

### 2. Background

As an example of the electric storage device, it is possible to use a secondary battery, such as lithium ion secondary battery. Recently, this kind of secondary battery is suitably used for a portable power supply for a personal computer, a portable terminal, or the like, a power supply for driving automobiles, such as battery electric vehicle (BEV), hybrid electric vehicle (HEV), and plug-in hybrid electric vehicle (PHEV), or the like. Japanese Patent Application Publication No. 2017-050142 discloses a negative electrode active material for the lithium ion secondary battery. The negative electrode active material includes scaly graphites and a scaly silicon particle whose surface is covered with a carbon. The scaly graphites aggregate so as to form a particle shape. The silicon particle is present between the scaly graphites. This publication describes that it is possible by using the negative electrode active material including the above described configuration to implement the lithium ion secondary battery having a higher capacity and a longer life.

### SUMMARY

Anyway, the present inventor thinks to suppress a capacity deterioration at a time when an electric charge is performed on the electric storage device.

The herein disclosed electric storage device includes a nonaqueous electrolytic solution. The nonaqueous electrolytic solution contains a nonaqueous solvent and an additive agent A. The nonaqueous solvent is carbonates. The additive agent A is at least one of 2-vinylpyridine, vinyl benzoate, 3,4-thiophenedicarboxylic anhydride, 1-ethyl-3-methylimidazolium methyl sulfate, 1-ethyl-3-methylimidazolium ethyl sulfate, 1-ethyl-3-methylimidazolium methylphosphonate, and 1-ethyl-3-methylimidazolium bis(perfluoroethylsulfonyl)imide. In accordance with such a configuration, it is possible to suppress the capacity deterioration at the time when the electric charge is performed on the electric storage device.

### BRIEF DESCRIPTION OF THE DRAWINGS

FIG. 1 is a longitudinal cross section view of a lithium ion secondary battery 100.

FIG. 2 is a schematic view of an electrode assembly 20.

FIG. 3 is a graph that shows a relation between a reaction resistance of a positive electrode and a positive electrode potential.

### DESCRIPTION OF THE EMBODIMENTS

Below, one embodiment of a herein disclosed electric storage device will be explained. The embodiment explained herein is not intended to particularly restrict a herein disclosed technique. The herein disclosed technique is not restricted within the embodiment explained herein, unless specifically mentioned. Drawings are shown schematically, and do not always reflect an actual object. The members/parts providing the same effect are suitably provided with the same numerals and signs, and overlapping explanations might be omitted. A wording “A to B” representing a numerical value range means “equal to or more than A and not more than B” unless specifically mentioned, and semantically covers “more than A and less than B”, too.

In the present specification, the wording “electric storage device” means a device that generates electric charge and electric discharge by a charge carrier moving between a pair of electrodes (a positive electrode and a negative electrode) through an electrolyte. The electric storage device semantically covers a secondary battery, such as lithium ion secondary battery, nickel hydrogen battery, and nickel cadmium battery, and a capacitor, such as lithium ion capacitor and electric double layer capacitor. Below, the embodiment will be described in a case where the electric storage device is the lithium ion secondary battery.

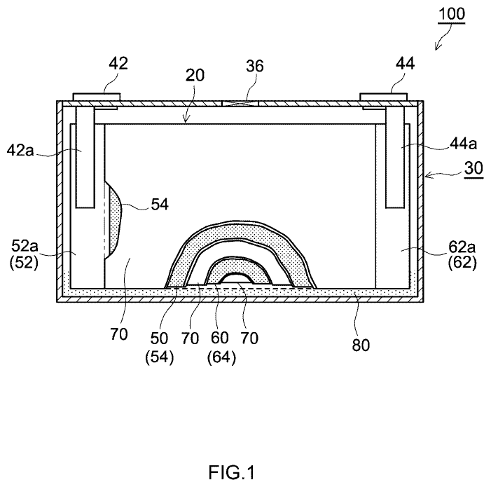

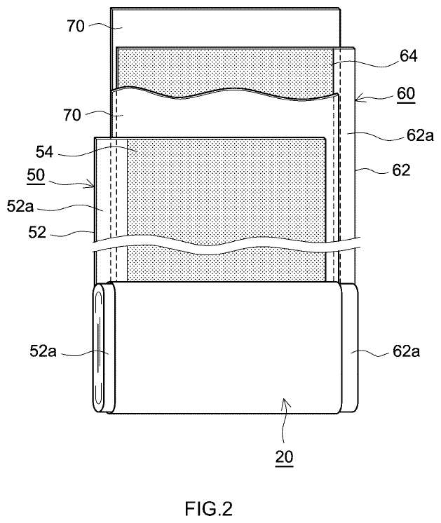

FIG. 1 is a longitudinal cross section view of a lithium ion secondary battery 100. FIG. 2 is a schematic view of an electrode assembly 20. As shown in FIG. 1, the lithium ion secondary battery 100 includes the electrode assembly 20, a case 30, and a nonaqueous electrolytic solution 80.

As shown in FIG. 1 and FIG. 2, the electrode assembly 20 is a wound electrode assembly, in which a positive electrode 50 formed in a long sheet shape and a negative electrode 60 formed in a long sheet shape are superimposed in a sheet longitudinal direction (Below, simply referred to as “longitudinal direction”, too) via a separator 70 formed in a long sheet shape and then wound therein. In the electrode assembly 20, an exposed area 52a of the positive electrode 50 and an exposed area 62a of the negative electrode 60 are respectively configured to protrude outwardly from both ends in a shorter direction orthogonal to the longitudinal direction.

As shown in FIG. 1 and FIG. 2, the positive electrode 50 includes a positive electrode collecting foil 52 formed in a long sheet shape and includes a positive electrode active material layer 54. The positive electrode collecting foil 52 is, for example, an aluminum foil. In this embodiment, the positive electrode collecting foil 52 includes an area on which the positive electrode active material layer 54 is provided, and includes the exposed area 52a on which the positive electrode active material layer 54 is not provided and a surface of the positive electrode collecting foil 52 is exposed. The positive electrode active material layer 54 is, for example, provided on one surface or both surfaces (here, on both surfaces) of the positive electrode collecting foil 52 along the longitudinal direction in a strip-like shape. The positive electrode active material layer 54 is not provided at an end part (an end part at a left side in a drawing) in a sheet shorter direction (below, simply referred to as “shorter direction”, too). The exposed area 52a herein is a strip-like area at the end part (the end part at the left side in the drawing) in the shorter direction. As shown in FIG. 1, an electrical collector plate 42a is attached to the exposed area 52a.

The positive electrode active material layer 54 includes, for example, a positive electrode active material. The positive electrode active material is not particularly restricted if an effect of the herein disclosed technique is implemented, and it is possible to use a positive electrode active material that is used for this kind of purpose and that has a conventionally known composition. It is good that the positive electrode active material is, for example, a lithium composite oxide, a lithium transition metal phosphate compound, or the like. A crystal structure of the positive electrode active material, which is not particularly restricted, might be a layered structure, a spinel structure, an olivine structure, or the like.

It is preferable that the lithium composite oxide is a lithium-transition metal complex oxide containing at least 1 kind of Ni, Co, and Mn as a transition metal element. As the lithium-transition metal complex oxide, it is possible to use, for example, a lithium nickel composite oxide, a lithium cobalt composite oxide, a lithium manganese composite oxide, a lithium nickel manganese composite oxide, a lithium nickel cobalt manganese composite oxide, a lithium nickel cobalt aluminum composite oxide, a lithium iron nickel manganese composite oxide, or the like. Regarding these positive electrode active materials, 1 kind might be used singly, or 2 or more kinds might be mixed so as to be used.

Incidentally, the wording “lithium nickel cobalt manganese composite oxide” in the present specification is a term that semantically covers not only an oxide in which Li, Ni, Co, Mn, or O is a constituent element, but also an oxide containing 1 kind or 2 or more kinds of additive elements other than them. As the additive element, it is possible to use, for example, a transition metal element, such as Mg, Ca, Al, Ti, V, Cr, Y, Zr, Nb, Mo, Hf, Ta, W, Na, Fe, Zn, and Sn, a typical metal element, or the like. The additive element might be a semimetal element, such as B, C, Si, and P, a non-metal element, such as S, F, Cl, Br, and I, or the like. This is similarly true even to the above described lithium nickel composite oxide, lithium cobalt composite oxide, lithium manganese composite oxide, lithium nickel manganese composite oxide, lithium nickel cobalt aluminum composite oxide, lithium iron nickel manganese composite oxide, or the like.

As the lithium transition metal phosphate compound, it is possible to use, for example, lithium iron phosphate (LiFePO₄), lithium manganese phosphate (LiMnPO₄), lithium manganese iron phosphate, or the like.

As the positive electrode active material, it is possible to preferably use, for example, LiNi_{0.33}Co_{0.33}Mn_{0.33}O₂, LiNi_{0.5}Co_{0.2}Mn_{0.3}O₂, LiNi_{0.6}Co_{0.2}Mn_{0.2}O₂, LiNi_{0.8}CO_{0.1}Mn_{0.1}O₂, LiNiO₂, LiCoO₂, LiFeO₂, LiMn₂O₄, LiNi_{0.5}Mn_{1.5}O₄, or the like.

The positive electrode active material layer 54 might contain an electrically conducting material, a binder, or the like, in addition to the positive electrode active material. As the electrically conducting material, it is possible to use, for example, a carbon black, such as acetylene black (AB), or the other carbon materials, such as graphite. As a binder, it is possible to use, for example, polyvinylidene fluoride (PVdF), or the like. A content amount of the positive electrode active material with respect to a whole of the positive electrode active material layer 54 is, for example, preferably equal to or more than 70 mass %, further preferably 80 mass % to 97 mass %, or furthermore preferably 85 mass % to 96 mass %. A content amount of the electrically conducting material with respect to the whole of the positive electrode active material layer 54 is, for example, 0.1 mass % to 20 mass %. A content amount of the binder with respect to the whole of the positive electrode active material layer 54 is, for example, 0.5 mass % to 15 mass %.

As shown in FIG. 1 and FIG. 2, the negative electrode 60 includes a negative electrode collecting foil 62 formed in a long sheet shape and a negative electrode active material layer 64. The negative electrode collecting foil 62 is, for example, a copper foil. In this embodiment, the negative electrode collecting foil 62 includes an area on which the negative electrode active material layer 64 is provided, and an exposed area 62a on which the negative electrode active material layer 64 is not provided and a surface of the negative electrode collecting foil 62 is exposed. The negative electrode active material layer 64 is, for example, provided on one surface or both surfaces (here, on both surfaces) of the negative electrode collecting foil 62 along the longitudinal direction in a strip-like shape. The negative electrode active material layer 64 is not provided at an end part (an end part at a right side in a drawing) in the shorter direction. The exposed area 62a herein is a strip-like area at the end part (the end part at the right side in the drawing) in the shorter direction. As shown in FIG. 1, an electrical collector plate 44a is attached to the exposed area 62a.

The negative electrode active material layer 64 includes, for example, a negative electrode active material. The negative electrode active material is not particularly restricted if the effect of the herein disclosed technique is implemented, and it is possible to use a conventionally known negative electrode active material used for this kind of purpose. The negative electrode active material is not particularly restricted if the effect of the herein disclosed technique is implemented, and it is good that the negative electrode active material is, for example, a carbon material, such as graphite, hard carbon, and soft carbon, a silicon (Si), or the like. A content amount of the negative electrode active material with respect to a whole of the negative electrode active material layer 64 is, for example, preferably equal to or more than 70 mass %, further preferably 80 mass % to 99 mass %, or furthermore preferably 85 mass % to 98 mass %.

The negative electrode active material layer 64 might include a binder, a thickening agent, or the like, in addition to the negative electrode active material. As the binder, it is possible to use, for example, a styrene butadiene rubber (SBR), or the like. A content amount of the binder with respect to the whole of the negative electrode active material layer 64, which is not particularly restricted, is 0.1 mass % to 8 mass %, for example. As the thickening agent, it is possible to preferably use, for example, carboxymethyl cellulose (CMC), or the like. A content amount of the thickening agent with respect to the whole of the negative electrode active material layer 64, which is not particularly restricted, is 0.3 mass % to 3 mass %, for example.

As the separator 70, it is possible to use, for example, a porous sheet (a film) made from a resin material, such as polyethylene (PE), polypropylene (PP), polyester, cellulose, and polyamide. The porous sheet might have a single-layer structure, or might have a laminate structure consisting of two or more layers (for example, a three-layers structure in which PP layers are laminated on both surfaces of the PE layer). On a surface of the separator 70, a heat resistance layer (HRL) might be provided.

The case 30 is, for example, an exterior container configured to accommodate the electrode assembly 20 and the nonaqueous electrolytic solution 80. The case 30 herein is a flat and square-shaped case. As shown in FIG. 1, the case 30 includes a positive electrode terminal 42, a negative electrode terminal 44, a safe valve 36, and a liquid injection hole (not shown in drawings). The positive electrode terminal 42 is, for example, a terminal for an outside connection at a positive electrode side. The positive electrode terminal 42 herein is electrically connected to the positive electrode 50 of the electrode assembly 20 via an electrical collector plate 42a. The negative electrode terminal 44 is, for example, a terminal for the outside connection at a negative electrode side. The negative electrode terminal 44 herein is electrically connected to the negative electrode 60 of the electrode assembly 20 via an electrical collector plate 44a. The safe valve 36 is, for example, a thin-walled part that is set to release an internal pressure of the case 30 when the internal pressure rises to be equal to or more than a predetermined level. The liquid injection hole is, for example, a portion for injecting the nonaqueous electrolytic solution 80 into the case 30.

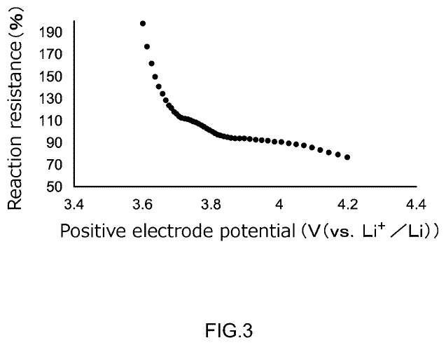

Anyway, the present inventor has examined a relation between a reaction resistance of the positive electrode and a positive electrode potential on the lithium ion secondary battery. The results are shown in FIG. 3. FIG. 3 is a graph that shows the relation between the reaction resistance of the positive electrode and the positive electrode potential. A vertical axis of a graph in FIG. 3 represents “reaction resistance (%)”, and represents a relative value in which the reaction resistance at a time of the positive electrode potential being 3.8 V (vs. Li/Li) is treated as 100%. A horizontal axis of the graph in FIG. 3 represents “positive electrode potential (V (vs. Li/Li))”. FIG. 3 shows that the reaction resistance of the positive electrode becomes higher as the positive electrode potential is lower. The reaction resistance of the positive electrode is shown to become further higher than the reaction resistance at a state of the positive electrode potential being equal to or more than 3.7 V (vs. Li/Li) when a state is satisfied where the positive electrode potential is less than 3.7 V (vs. Li/Li). The present inventor thought that this phenomenon was caused by a change in a crystal structure of the positive electrode active material being bigger under a state where the positive electrode potential was smaller than 3.7 V (vs. Li/Li), and that a capacity deterioration was accelerated if the lithium ion secondary battery was made to be in an electric charge state under the above described state.

Thus, the present inventor thought that the capacity deterioration caused by the electric charge on the lithium ion secondary battery was supposed to be suppressed if it became possible under a state where a voltage of the lithium ion secondary battery was 3.0 V to make the positive electrode potential become larger so as to make the positive electrode potential close to 3.7 V (vs. Li/Li), or preferably so as to make the positive electrode potential be equal to or more than 3.7 V (vs. Li/Li). Then, the present inventor found, as a result of an intensive study, that it was possible, by increasing an irreversible capacity of the negative electrode of the lithium ion secondary battery due to a configuration of the electrolytic solution described later, to make the positive electrode potential at the time when the battery voltage was 3.0 V be larger and consequently to suppress the capacity deterioration at the electrically charging time.

The nonaqueous electrolytic solution 80 contains, for example, a nonaqueous solvent. In this embodiment, the nonaqueous solvent is carbonates. As the carbonates, it is possible to use, for example, ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), trifluoro dimethyl carbonate (TFDMC), or the like. As the nonaqueous solvent, 1 kind of the nonaqueous solvents might be used singly, or 2 or more kinds of the nonaqueous solvents might be mixed so as to be used.

The nonaqueous electrolytic solution 80 contains, for example, an additive agent A. As the additive agent A, it is possible to use, for example, 2-vinylpyridine, vinyl benzoate, 3,4-thiophenedicarboxylic anhydride, 1-ethyl-3-methylimidazolium methyl sulfate, 1-ethyl-3-methylimidazolium ethyl sulfate, 1-ethyl-3-methylimidazolium methylphosphonate, 1-ethyl-3-methylimidazolium bis(perfluoroethylsulfonyl)imide, or the like. As the additive agent A, 1 kind of the above described chemical compounds might be used singly, or 2 or more kinds of the chemical compounds might be mixed so as to be used. Incidentally, below, chemical structural formulas of the above described chemical compounds are shown in this order.

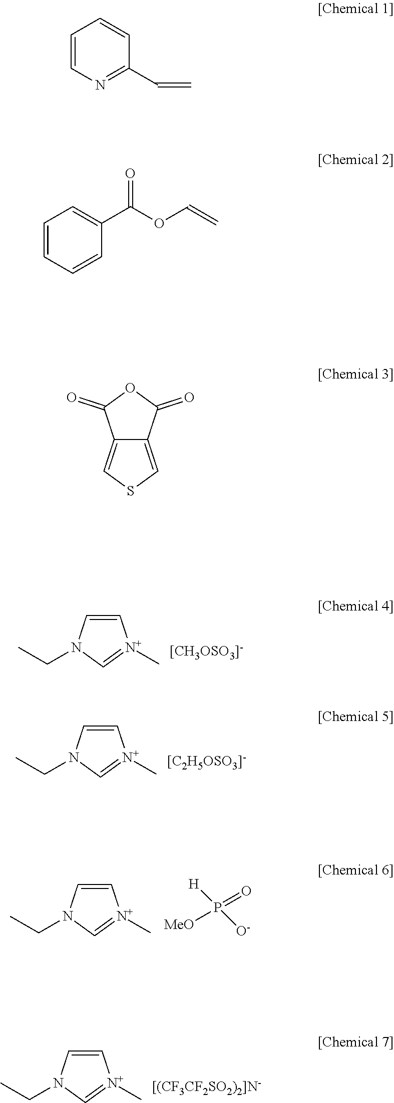

It is good that a content amount of the additive agent A with respect to a whole of the nonaqueous electrolytic solution 80 is set to be approximately 0.1 mass % to 5 mass %. From a perspective of efficiently implementing the effect of the herein disclosed technique, the content amount of the additive agent A is preferably equal to or more than 0.25 mass %, further preferably equal to or more than 0.5 mass %, furthermore preferably equal to or more than 0.75 mass %, or preferably in particular equal to or more than 1 mass %. On the other hand, from a perspective of shortening an electrically charging time period of the lithium ion secondary battery 100, a content amount of the additive agent A is preferably equal to or less than 3 mass %, further preferably equal to or less than 2.5 mass %, or furthermore preferably equal to or less than 2.25 mass %.

The nonaqueous electrolytic solution 80 might contain, for example, a supporting salt. As the supporting salt, for example, it is possible to use a lithium salt, such as LiPF₆, LiBF₄, and LiCIO₄. It is good that a concentration of the supporting salt is, for example, 0.7 mol/L to 1.3 mol/L.

The nonaqueous electrolytic solution 80 might contain an additive agent B different from the additive agent A, as needed. It is good that the additive agent B is an additive agent used for this kind of purpose. As the additive agent B, it is possible to use, for example, a coating-film forming agent, such as LiB(C₂O₄)₂(LiBOB), LiBF₂(C₂O₄), and fluoro phosphate (preferably, difluoro phosphate, such as difluoro lithium phosphate (LiPO₂F₂)), a gas generating agent, such as biphenyl (BP) and cyclohexylbenzene (CHB), a thickening agent, or the like.

The lithium ion secondary battery 100 can be used for various purposes. As a suitable purpose, it is possible to use it for a driving power supply that is mounted on a vehicle, such as battery electric vehicle (BEV), hybrid electric vehicle (HEV), and plug-in hybrid electric vehicle (PHEV). The lithium ion secondary battery 100, for example, could be used as a storage battery, such as small electric power storing apparatus. The lithium ion secondary battery 100 can be used, for example, in a form of a battery pack in which plural lithium ion secondary batteries are connected in series and/or parallel.

As described above, the lithium ion secondary battery 100, which is an example of the herein disclosed electric storage device, includes the nonaqueous electrolytic solution 80. The nonaqueous electrolytic solution includes the nonaqueous solvent and the additive agent A. The nonaqueous solvent is carbonates. The additive agent A is at least one of 2-vinylpyridine, vinyl benzoate, 3,4-thiophenedicarboxylic anhydride, 1-ethyl-3-methylimidazolium methyl sulfate, 1-ethyl-3-methylimidazolium ethyl sulfate, 1-ethyl-3-methylimidazolium methylphosphonate, and 1-ethyl-3-methylimidazolium bis(perfluoroethylsulfonyl)imide.

The nonaqueous electrolytic solution 80 used in the lithium ion secondary battery 100 includes the additive agent A. The additive agent A is a component that hardly rises an interface resistance of the negative electrode 60, but can accelerate a decomposition of the electrolytic solution on a surface of the negative electrode active material. In other words, regarding the lithium ion secondary battery 100, the additive agent A contained in the nonaqueous electrolytic solution 80 induces the decomposition of a part of the electrolytic solution coming into contact with the surface of the negative electrode active material, so as to increase the irreversible capacity of the negative electrode 60. The present inventor supposes about this mechanism that, by using the nonaqueous electrolytic solution containing the additive agent A, a thicker coating film is generated on the negative electrode active material layer 64, the Li taken in the coating film is increased, desorption insertion of the Li becomes to hardly occur, and thus the irreversible capacity of the negative electrode 60 is increased. The present inventor supposes that it is, otherwise, caused by forming the coating film containing more Li per unit volume. By increasing the irreversible capacity of the negative electrode 60, it is possible to make the positive electrode potential be higher when the battery voltage is 3.0 V (in other words, when the lithium ion secondary battery 100 is at SOC 0%). By this, under a state of the positive electrode potential with which the reaction resistance is higher than the other state, it is possible to make the lithium ion secondary battery 100 become hardly in the electric charge state. Thus, it is possible to suppress the capacity deterioration at the electrically charging time of the lithium ion secondary battery 100.

The nonaqueous electrolytic solution 80 might contain the additive agent A equal to or more than 1 mass % with respect to the whole of the nonaqueous electrolytic solution 80. By increasing the content amount of the additive agent A of the nonaqueous electrolytic solution 80, it is possible to enhance an effect of making the positive electrode potential be larger when the battery voltage is 3.0 V. By making the content amount of the additive agent A of the nonaqueous electrolytic solution 80 be equal to or more than 1 mass % with respect to the whole of the nonaqueous electrolytic solution 80, it is possible to implement a shortening effect of the electrically charging time period, in addition to the capacity deterioration suppressing effect at the electrically charging time.

The additive agent A might be vinyl benzoate, 1-ethyl-3-methylimidazolium methyl sulfate, 1-ethyl-3-methylimidazolium ethyl sulfate, 1-ethyl-3-methylimidazolium methylphosphonate, or 1-ethyl-3-methylimidazolium bis(perfluoroethylsulfonyl)imide. By using the additive agent A configured with any of them, it is possible to expect further enhancement of the shortening effect for the electrically charging time period. On the negative electrode active material (for example, the graphite) contained in the negative electrode active material layer 64, the coating film is formed by the decomposition of the additive agent. Regarding this coating film, according to the kind of the decomposed additive agent, an electrical conductivity (the resistance) of the Li is changed. It is supposed that, even in a case where a decomposition amount of the additive agent is much and the coating film becomes thicker (in other words, in a case where the irreversible capacity is large), one contributing in inducing the coating film, whose resistance is low, is the above described additive agent.

Although not particularly restricting, the shortening effect of the electrically charging time period tends to be preferably implemented, for example, with a configuration in which the positive electrode potential becomes equal to or more than 3.7 V (vs. Li/Li) when the battery voltage is 3.0 V (in other words, the lithium ion secondary battery 100 is at the SOC 0%). If the electric charge of the lithium ion secondary battery 100, being under a state where the positive electrode potential is less than 3.7 V (vs. Li/Li) and the reaction resistance is higher than the other state, can be avoided, it is possible to perform the electric charge on the lithium ion secondary battery 100 from the SOC 0% to SOC 100% while the reaction resistance is kept in an approximately constant state. For example, at the electrically charging time of the lithium ion secondary battery 100, it is possible to omit a control of the current value according to the positive electrode potential, or the like, and thus it is possible to implement the shortening effect of the electrically charging time period. Furthermore, it is possible to implement a rapid electrical charge, while suppressing the capacity deterioration.

It is good that the lithium ion secondary battery 100 further includes the positive electrode 50 including the positive electrode active material layer 54, and includes the negative electrode 60 including the negative electrode active material layer 64. It is good even if the positive electrode active material layer 54 includes the lithium nickel cobalt manganese composite oxide as the positive electrode active material. The negative electrode active material layer might include the graphite as the negative electrode active material. By this, it is possible to implement a configuration that is further suitable for suppressing the capacity deterioration at the electrically charging time of the lithium ion secondary battery 100.

Incidentally, as an example, the lithium ion secondary battery 100 has been explained that has included the wound electrode assembly (the electrode assembly 20) formed in the flat shape and that has been formed in the square shape. The lithium ion secondary battery might be configured as a lithium ion secondary battery including a laminate type electrode assembly (in other words, an electrode assembly in which plural positive electrodes and plural negative electrodes are alternately laminated). The lithium ion secondary battery might be configured as a cylindrical lithium ion secondary battery, a laminate type lithium ion secondary battery, or the like.

Below, a test example related to the herein disclosed technique would be explained, but it is not intended that the herein disclosed technique is restricted to one shown in the below described test example.

### Example 1 to Example 3

The graphite as the negative electrode active material, the styrene butadiene rubber (SBR) as the binder, and the carboxymethyl cellulose (CMC) as the thickening agent were prepared. These were mixed with water as the solvent to satisfy a mass ratio of graphite: SBR: CMC=98:1:1, so as to manufacture a negative electrode paste. The negative electrode paste was applied in a strip-like shape to coat both surfaces of the long copper foil, dried, and then pressed, and thus the negative electrode sheet was obtained.

The LiNi₁₃Co₁₃Mn₁₃O₂ (LNCM) as the positive electrode active material, the acetylene black (AB) as the electrically conducting material, and the polyvinylidene fluoride (PVdF) as the binder were prepared. These were mixed with N-methylpyrrolidone (NMP) as the solvent to satisfy a mass ratio of LNCM: AB: PVdF=90:8:2, so as to manufacture a positive electrode paste. The positive electrode paste was applied in a strip-like shape to coat both surfaces of the long aluminum foil, dried, and then pressed, and thus the positive electrode sheet was obtained.

As the separator, a separator sheet was prepared in which the HRL was provided on the porous polyolefin sheet having the three-layers structure of PP/PE/PP. The positive electrode sheet, the negative electrode sheet, and 2 separator sheets were laminated, wound, and then pressed from a side surface direction to be squashed, and thus the wound electrode assembly formed in the flat shape was manufactured.

Next, a positive electrode terminal and a negative electrode terminal were connected to the wound electrode assembly, and then the resultant was accommodated in a square-shaped case including the liquid injection hole for the electrolytic solution. Then, the nonaqueous electrolytic solution was injected from the liquid injection hole, and then the liquid injection hole was airtightly sealed. Incidentally, the nonaqueous electrolytic solution was prepared in which the LiPF₆ as the supporting salt was dissolved at 1.1 mol/L concentration into a mix solvent containing the ethylene carbonate (EC), the dimethyl carbonate (DMC), and the ethyl methyl carbonate (EMC) as the nonaqueous solvents at a volume ratio of EC: DMC: EMC=3:3:4, and furthermore in which the 2-vinylpyridine (made by Tokyo Chemical Industry Co., Ltd.) as the additive agent A was added to reach an added amount described in “added amount (mass %)” column of Table 1. The added amount described in a corresponding column of Table 1 is a content amount (mass %) of the additive agent A when the whole of the nonaqueous electrolytic solution was treated as 100 mass %. After that, an aging process was performed so that an evaluation lithium ion secondary battery for each example was obtained.

### Example 4 to Example 6

As the additive agent A, the vinyl benzoate (made by Tokyo Chemical Industry Co., Ltd.) was used. An added amount of the additive agent A was as shown in “added amount (mass %)” column of Table 1. Regarding the other things, the same material and the same procedure as Example 1 to Example 3 were used, and thus the evaluation lithium ion secondary battery for each example was obtained.

### Example 7 to Example 9

As the additive agent A, 3,4-thiophenedicarboxylic anhydride (made by Tokyo Chemical Industry Co., Ltd.) was used. An added amount of the additive agent A was as shown in “added amount (mass %)” column of Table 1. Regarding the other things, the same material and the same procedure as Example 1 to Example 3 were used, and thus the evaluation lithium ion secondary battery for each example was obtained.

### Example 10 to Example 12

As the additive agent A, the 1-ethyl-3-methylimidazolium methyl sulfate (EMI-methyl sulfate) (made by Tokyo Chemical Industry Co., Ltd.) was used. An added amount of the additive agent A was as shown in “Added amount (mass %)” column of Table 1. Regarding the other things, the same material and the same procedure as Example 1 to Example 3 were used, and thus the evaluation lithium ion secondary battery for each example was obtained.

### Example 13

As the additive agent A, the 1-ethyl-3-methylimidazolium bis(perfluoroethylsulfonyl)imide (EMI-bis(perfluoroethylsulfonyl)imide) (made by Tokyo Chemical Industry Co., Ltd.) was used. The added amount of the additive agent A was 2 mass %. Regarding the other things, the same material and the same procedure as Example 1 to Example 3 were used, and thus the evaluation lithium ion secondary battery for the present example was obtained.

### Example 14

As the additive agent A, the 1-ethyl-3-methylimidazolium methylphosphonate (EMI-methylphosphonate) (made by Tokyo Chemical Industry Co., Ltd.). The added amount of the additive agent A was 1.5 mass %. Regarding the other things, the same material and the same procedure as Example 1 to Example 3 were used, and thus the evaluation lithium ion secondary battery for the present example was obtained.

### Example 15

As the additive agent A, the 1-ethyl-3-methylimidazolium ethyl sulfate (EMI-ethyl sulfate) (made by Tokyo Chemical Industry Co., Ltd.) was used. The added amount of the additive agent A was 1.5 mass %. Regarding the other things, the same material and the same procedure as Example 1 to Example 3 were used, and thus the evaluation lithium ion secondary battery for the present example was obtained.

### Example 16

The additive agent A was not used. Regarding the other things, the same material and the same procedure as Example 1 to Example 3 were used, and thus the evaluation lithium ion secondary battery for the present example was obtained.

### <Cycle Test>

Each of the evaluation lithium ion secondary batteries was kept under an environment at 25° C. This was subjected to a constant current (CC)—constant voltage (CV) electric charge (cut current: 1/50 C) at 1/5 C current value till 4.1 V, a pause for 10 minutes was applied, and then a constant current electric discharge was performed at 1/5 C current value till 3.0 V. An electric discharge capacity at that time was measured, and it was treated as an initial capacity. Next, on each evaluation lithium ion secondary battery, a cycle consisted of a CCCV electric charge and a CCCV electric discharge with a voltage range being 3.0 V to 4.2 V was repeated to be 500 cycles. The current value at the electrically charging time was 5 C. The current value at the electrically discharging time was 1 C. The capacity after the 500 cycles was measured by a procedure the same as measurement for the initial capacity. Then, a capacity retention rate was obtained by capacity retention rate (%)=(capacity after 500 cycles/initial capacity)×100. As the capacity retention rate of the evaluation lithium ion secondary battery for each example, a relative value when the capacity retention rate of Example 16 was treated as 100 was calculated. The result is shown in “Capacity retention rate” column of Table 1.

### <Measurement of Positive Electrode Potential>

Each evaluation lithium ion secondary battery was subjected to the electric discharge till 3.0 V (till SOC 0%). The positive electrode potential of each evaluation lithium ion secondary battery at that time was measured. Incidentally, regarding the measurement of the positive electrode potential, a reference electrode was stored between the positive electrode and the negative electrode, and then it was calculated on the basis of an electric potential difference in this reference electrode and positive electrode. The reference electrode was a reference electrode that was used for this kind of purpose and that was manufactured with lithium iron phosphate. The result is shown in “Positive electrode potential (V(Li⁺/Li))” column of Table 1.

### <Measurement of Electrically Charging Time Period>

Each evaluation lithium ion secondary battery was subjected to the electric discharge till 3.0 V (till SOC 0%). Then, by an constant output of 100 W, each evaluation lithium ion secondary battery was subjected to the electric charge till 1 Ah. A time period required for this electric charge was measured. As the electrically charging time period of each example of the evaluation lithium ion secondary battery, a relative value when the electrically charging time period of Example 16 was treated as 100 was calculated. The result is shown in “Electrically charging time period” column of Table 1. Incidentally, a constant output condition of 100 W of the electric charge is an electric charge condition imitating so-called rapid electric charge.

TABLE 1

| | | | | Positive | |
|---|---|---|---|---|---|
| | Additive agent A | | | electrode | |
| | | Added | Capacity | potential | Electrically |
| | | amount | retention | (V(vs. Li⁺/ | charging |
| | Kind | (mass %) | rate | Li)) | time period |
| Example 1 | 2-Vinylpyridine | 0.5 | 102 | 3.64 | 112 |
| Example 2 | | 1 | 105 | 3.68 | 107 |
| Example 3 | | 1.5 | 112 | 3.73 | 103 |
| Example 4 | Vinyl benzoate | 0.5 | 103 | 3.65 | 101 |
| Example 5 | | 1 | 116 | 3.72 | 95 |
| Example 6 | | 1.5 | 114 | 3.81 | 97 |
| Example 7 | 3,4-Thiophenedicarboxylic | 0.5 | 104 | 3.62 | 119 |
| | anhydride | | | | |
| Example 8 | | 1 | 109 | 3.69 | 110 |
| Example 9 | | 1.5 | 116 | 3.76 | 107 |
| Example 10 | EMI-methyl sulfate | 0.5 | 103 | 3.65 | 98 |
| Example 11 | | 1 | 118 | 3.71 | 84 |
| Example 12 | | 1.5 | 120 | 3.79 | 88 |
| Example 13 | EMI- | 2 | 113 | 3.70 | 98 |
| | bis(perfluoroethylsulfonyl)imide | | | | |
| Example 14 | EMI-methylphosphonate | 1.5 | 110 | 3.77 | 90 |
| Example 15 | EMI-ethyl sulfate | 1.5 | 116 | 3.73 | 82 |
| Example 16 | — | — | 100 | 3.62 | 100 |

As shown in Table 1, the lithium ion secondary batteries of Example 1 to Example 15 include the nonaqueous electrolytic solution that contains the nonaqueous solvent being carbonates and contains the additive agent A. The lithium ion secondary battery of Example 16 does not include the nonaqueous electrolytic solution containing the additive agent A. It was shown that, in the lithium ion secondary batteries of Example 1 to Example 15, the capacity deterioration at the electrically charging time was suppressed with respect to the lithium ion secondary battery of Example 6.

The herein disclosed technique could contain techniques recited in the following items.

Item 1: An electric storage device, comprising: a nonaqueous electrolytic solution, wherein
the nonaqueous electrolytic solution comprises:
a nonaqueous solvent that is carbonates; and
an additive agent A that is at least one of
2-vinylpyridine,
vinyl benzoate,
3,4-thiophenedicarboxylic anhydride,
1-ethyl-3-methylimidazolium methyl sulfate,
1-ethyl-3-methylimidazolium ethyl sulfate,
1-ethyl-3-methylimidazolium methylphosphonate, and
1-ethyl-3-methylimidazolium bis(perfluoroethylsulfonyl)imide.

Item 2: The electric storage device recited in item 1, wherein
the nonaqueous electrolytic solution comprises equal to or more than 1 mass % of the additive agent A with respect to a whole of the nonaqueous electrolytic solution.

Item 3: The electric storage device recited in item 1 or 2, wherein
the additive agent A is
vinyl benzoate,
1-ethyl-3-methylimidazolium methyl sulfate,
1-ethyl-3-methylimidazolium ethyl sulfate,
1-ethyl-3-methylimidazolium methylphosphonate, or
1-ethyl-3-methylimidazolium bis(perfluoroethylsulfonyl)imide.

Item 4: The electric storage device recited in any one of items 1 to 3, further comprising:
a positive electrode that comprises a positive electrode active material layer; and
a negative electrode that comprises a negative electrode active material layer, wherein
the positive electrode active material layer contains a lithium nickel cobalt manganese composite oxide as a positive electrode active material, and
the negative electrode active material layer contains a graphite as a negative electrode active material.

Above, embodiments of the herein disclosed technique have been explained, but these are merely illustrations, and are not intended to restrict the scope of claims. The technique recited in claims contains matters in which the above-illustrated specific example is variously deformed or changed.

What is claimed is:

1. An electric storage device, comprising: a nonaqueous electrolytic solution, wherein
the nonaqueous electrolytic solution comprises:
a nonaqueous solvent that is carbonates; and
an additive agent A that is at least one of
2-vinylpyridine,
vinyl benzoate,
3,4-thiophenedicarboxylic anhydride,
1-ethyl-3-methylimidazolium methyl sulfate,
1-ethyl-3-methylimidazolium ethyl sulfate,
1-ethyl-3-methylimidazolium methylphosphonate, and
1-ethyl-3-methylimidazolium bis(perfluoroethylsulfonyl)imide.

2. The electric storage device according to claim 1, wherein
the nonaqueous electrolytic solution comprises equal to or more than 1 mass % of the additive agent A with respect to a whole of the nonaqueous electrolytic solution.

3. The electric storage device according to claim 2, wherein
the additive agent A is
vinyl benzoate,
1-ethyl-3-methylimidazolium methyl sulfate,
1-ethyl-3-methylimidazolium ethyl sulfate,
1-ethyl-3-methylimidazolium methylphosphonate, or
1-ethyl-3-methylimidazolium bis(perfluoroethylsulfonyl)imide.

4. The electric storage device according to claim 1, further comprising:
a positive electrode that comprises a positive electrode active material layer, and
a negative electrode that comprises a negative electrode active material layer, wherein
the positive electrode active material layer contains a lithium nickel cobalt manganese composite oxide as a positive electrode active material, and
the negative electrode active material layer contains a graphite as a negative electrode active material.
